(19) United States
(12) Patent Application Publication
(10) Pub. No.: US 2019/0286312 A1
(43) Pub. Date: Sep. 19, 2019

(54) HAPTIC FEEDBACK FOR A SCREEN

(71) Applicant: Audi AG, 85045 Ingolstadt (DE)

(72) Inventors: JACQUES HÉLOT, Ingolstadt (DE); IMMO REDEKER, Ingolstadt (DE); JORIS MERTENS, Ingolstadt (DE)

(73) Assignee: Audi AG, 85045 Ingolstadt (DE)

(21) Appl. No.: 16/318,849

(22) PCT Filed: Aug. 8, 2017
(86) PCT No.: PCT/EP2017/070023

§ 371 Date: Jan. 18, 2019

(30) Foreign Application Priority Data
Aug. 8, 2016 (DE) 10 2016 214 692.0

(51) Int. Cl. G06F 3/0484; G06F 3/01; G06F 3/0362

(52) U.S. Cl. CPC G06F 3/04847; G06F 3/0362; G06F 3/016

(57) ABSTRACT

In a method for controlling a function of an apparatus, a screen is mounted via a retaining element on an axis for rotation about the axis and can be shifted along the axis and in relation to a display unit. The function is selected in dependence on an orientation of the screen relative to the display unit. A switch is arranged on a movement path of the screen and can be activated in response to a tilting movement of the screen on the movement path in relation to the axis so as to activate or deactivate a control element for controlling the function.

The present invention relates to a method for controlling at least one function of an apparatus by means of at least one screen and to a user interface configured for executing the introduced method.

In order to provide feedback to a user of a screen, in particular haptic feedback, about a state of a function that is controlled by the screen, actuators are generally used which generate a feedback in the form of vibration pattern, when the function is operated. Such actuators are expensive, heavy and require much installation space.

German document DE 10 315 841 A1 introduces an operating device with haptic feedback for a motor vehicle, in which a touch-sensitive display is mounted in a base position via a spring element by means of a tiltable holder.

German document DE 10 2013 225 463 A1 discloses an operating device for an electric device, in which, for controlling a function, a tilting movement of a spring-mounted touch-sensitive operating device is realized.

International Publication WO 2016 012 277 A1 discloses for a vehicle component an operating unit which is mounted elastically movable via a support element.

Against this background, a method for controlling at least one function of an apparatus by means of at least one screen is introduced, wherein the at least one screen is arranged by at least one retaining element on at least one axis, and wherein the at least one screen is mounted for rotation about the at least one axis, and a movement of the at least one screen relative to the at least one axis activates at least one switch arranged on a movement path of the at least one screen, and wherein the activation of the at least one switch activates or deactivates a control element for controlling the at least one function.

Embodiments become apparent from the description and the dependent claims.

The introduced method is used, in particular for controlling a function of a vehicle by means of a screen, without a feedback of an input of a control command being confirmed via a vibration pattern and a corresponding actuator. For this purpose, the invention provides that the screen is rotatably arranged on an axis, so that the screen moves relative to the axis, or is pivoted about the axis or can be rotated or tilted on the axis, wherein the screen is moved in particular along a movement path, on which a switch is arranged, which is to be contacted or is contacted by the screen as a result of the rotation or tilting movement of the screen, and respectively to be activated, i.e. to be switched or activated, so that a control element displayed on the screen is to be activated or deactivated or is activated or deactivated.

The switch provided in accordance with the invention may be a button, pressure sensor, contact sensor or any other technically suitable element for detecting a change in position of the screen provided in accordance with the invention.

In order to mount or arrange the screen provided in accordance with the invention for rotation on a respective axis, it is provided that the screen is connected to the axis by means of a retaining element. The retaining element can be designed, for example, as part of the screen or separately of the screen, in particular in the form of a plug-in system. Provision is made in particular for the retaining element to be able to at least partially embrace the axis and to move relative to the axis, i.e. in at least one direction about the axis. The retaining element may, for example, have a recess for placement of the axis.

In the context of the present invention, a control element is to be understood as an element which is used for controlling, i.e. in particular suitable for activating or deactivating a function of an apparatus. A control element can, for example, be integrated in a switch or displayed on a screen. In particular, a control element can be displayed as a control symbol on a touch-sensitive screen and enable a control of the function by means of a touch gesture. Correspondingly, an activation of a respective control element results automatically in an activation of a corresponding function or a deactivation of the control element to a deactivation of the function.

In order to control a function of a respective apparatus, such as, e.g., a vehicle, in accordance with the introduced method provision is made in particular to shift a respective screen relative to the axis provided according to the invention, i.e. for example, tilted about the axis or moved laterally along the axis. As a result of a shift of the screen relative to the axis, a switch arranged in a movement path of the screen can be contacted and accordingly switched or activated accordingly by the screen. Depending on a switching state of the switch, a function of an apparatus or of a control element corresponding to the function, which is displayed, for example, on the screen, such as e.g. a radio function of a vehicle, can be activated or deactivated. This means that a defined movement of the screen relative to the at least one axis serves to activate the switch arranged on a movement path of the at least one screen.

According to a possible configuration of the introduced method, it is provided that the at least one screen is a touch-sensitive screen on which a control symbol associated with the control element is displayed, by means of which at least one sub-function of the at least one function is to be controlled.

In particular, it is provided that the screen provided according to the invention enables a control of a functionality in dependence on a respectively activated function, such as, e.g., a sub-function. This means that the screen itself is moved per se to select or to activate a respective function, and in addition a screen symbol, which, e.g. is configured as control symbol for receiving a touch gesture and which is displayed on the screen, is used to, e.g., adjust the respectively activated function or to control a sub-function of the function, e.g. by means of a touch sensor, Thus, provision may be made for example to shift the screen along a respective axis in order to activate a control element, provided from a multiplicity of control element for controlling a fan power (=function to be activated), by tilting the screen at level of the respective control element about the axis and to activate a switch arranged in a movement path of the screen. As soon as the switch for controlling the fan power is activated, the control element is activated and a control symbol appears on the screen with gradations of a fan activity scale, between which it is to be selected by tapping on the screen, which can be configured as a touch-sensitive screen for example.

The term “activating a function” in the context of the present invention relates to a procedure in which a function is switched to a state in which the function can be changed and, optionally, acted upon an apparatus associated to the function. A function can, for example, not only be activated or deactivated directly by means of an actuation of a switch initiated by a movement of the screen provided according to the invention, but in addition also be controlled further. As an alternative, the function may also be controlled by using a sub-function, which is controlled via at least one control symbol displayed on the screen.

According to a possible configuration of the introduced method, provision is made for the at least one axis, on which the at least one screen is arranged, to have at least one ball joint about which the at least one screen is to be rotated or rotatable.

By means of a ball joint, via which a connection between the screen according to the invention and the axis provided in accordance with the invention is implemented, there are many movement options for the screen, so that correspondingly many control elements can be activated and as a consequence respective functions associated to the respective control elements can be controlled.

To attach a respective screen to a respective ball joint, the retaining element provided according to the invention may be configured as clamp, which is pulled over a ball formed on a respective axis and/or the screen.

According to a further possible configuration of the introduced method, provision is made for the at least one screen to move relative to the at least one axis, i.e. in particular in longitudinal direction of the axis, and relative to a display unit, and for a selection of a respective function to be controlled by the at least one screen in dependence on an orientation of the at least one screen relative to the display unit.

It is conceivable that the screen provided according to the invention is used in combination with a further screen or a display unit to display respective control elements to be controlled by a movement of the screen or higher-level control elements to which respective control elements to be displayed on the screen are assigned. By moving the screen relative to the display unit, a respective control element to be controlled can be selected, so that a corresponding functionality, i.e. a corresponding sub-function, which is to be controlled by appropriate control elements on the screen, can be controlled by means of the screen. For this purpose, for example, a plurality of switches can be arranged on the display unit, which can be activated by a movement of the screen. Accordingly, the display unit is able to activate different menus for example for, for example, a vehicle technology and a comfort technology, which can be operated via the screen, when corresponding control elements, displayed on the screen, are activated.

Of course, a selection of a respective control element by means of the screen provided according to the invention enables direct control of a respective function of an apparatus and activation or deactivation of, for example, an interior lighting.

According to a further possible configuration of the introduced method, provision is made for an arrangement of the at least one screen on the at least one axis such that the at least one axis forms a horizontal axis, a vertical axis, or an applicator axis in relation to the at least one screen.

The screen provided according to the invention can be moved or tilted relative to each geometric axis, in particular relative to a rotation axis, about the axis provided according to the invention. As a result of a connection between axis and screen on the basis of a ball joint, the screen can be moved both horizontally and vertically in relation to the axis. In this case, the axis provided according to the invention can extend horizontally through the screen or along the screen. Furthermore, the axis provided according to the invention can extend vertically through the screen or along the screen or along a vertical axis, i.e. an applicator axis of the screen. This means that the axis provided according to the invention can extend along all geometric axes of the screen.

According to a further possible embodiment of the introduced method, provision is made for the at least one screen to act on at least one spring element which the at least one switch includes, when the at least one screen is moved relative to the at least one axis in order to activate or deactivate a control element for controlling a function, and to provide by means of the at least one spring element a haptic feedback of an activation state of the at least one function for a user.

By means of a spring element which, for example, can be accommodated in the switch provided according to the invention and configured, for example, as a button, a user may be provided with a haptic feedback, when the screen provided according to the invention is moved, to indicate an activity state of a respective function to be controlled. For this purpose, the spring element can act on the screen and, for example, exert a continuously increasing force in opposition to a force applied by a user to move the screen. The spring element can hereby be configured such that the force is provided only in the presence of a predefined activation state of the respective function, so that the user recognizes that, for example, a control element is not switchable, when no continuously increasing resistance is perceived as the screen moves towards the switch.

According to a further possible configuration of the introduced method, provision is made for the at least one switch to communicate with the at least one screen in order to transmit an activation state of the at least one function to the at least one screen and to display it on the at least one screen.

To expand with the screen provided according to the invention the functional range of a respective control element, and to provide, for example, sub-functions of a respective function associated to a control element, it is conceivable to transmit to the screen information about a function that is activated or deactivated by a movement of the screen. For this purpose, the screen can be connected via an interface, such as, e.g., a cable or a wireless interface, with a control unit, which is configured to activate the respective function in dependence on a corresponding movement of the screen.

According to a further possible configuration of the introduced method, provision is made for the at least one screen to be tilted about the at least one axis for activating or deactivating the at least one function.

To control a respective control element, i.e. to activate or deactivate, the screen provided according to the invention can be moved in any technically suitable type of movement about the axis provided according to the invention or along the axis. In particular, provision is made for the screen to be tilted about the axis and to be moved or to be movable, for example, between two stops, which can be configured, e.g. as switch.

According to a further possible configuration of the introduced method, provision is made for the at least one switch to be in operative contact with the at least one screen and to guide the screen when tilting about the axis along a predefined movement path, which, for example, corresponds to a rotation axis of the axis.

In order to keep the screen provided according to the invention laterally movable on the axis provided according to the invention and yet to allow safe activation of a control of a respective control element when moving the screen about the axis or along the axis, it is provided that the screen is guided by a switch, associated to a respective control element, along a predefined movement path, when the screen is positioned in the effective range of a respective switch. For this purpose, the switch can provide, e.g., a path for a sensor of the screen, wherein a mechanical spring can be arranged on the path, by which a force opposes the sensor, when the sensor moves on the path, so that a user moving the screen perceives a haptic feedback about the movement of the sensor on the path in the direction of the respective control element.

Furthermore, the present invention relates to a user interface with at least one screen arranged on an apparatus, at least one retaining element, at least one switch, and at least one axis, wherein the at least one screen is rotatably mounted via the at least one retaining member about the at least one axis, wherein a movement of the at least one screen relative to the at least one axis serves to activate the switch arranged on a movement path of the at least one screen, and wherein the at least one screen includes a control unit which is configured to detect an activation of the at least one switch and in response to the activation of the at least one switch, to activate or deactivate a control element for controlling at least one function of the apparatus.

The introduced user interface is used in particular for carrying out the introduced method.

According to a possible configuration of the introduced user interface, provision is made for the at least one switch to include at least one spring element, and for the at least one switch to be configured to automatically guide the at least one screen on a movement path, when the at least one screen is moved relative to the at least one axis. As a result, a controlled guidance of the screen is ensured when the screen is moved.

Due to a movement path provided by a respective switch, i.e. a structure on which, for example, a sensor of a respective screen moves, a movement path, i.e. a trajectory, of the screen is predefined, so that the screen moves accurately toward a predefined point and activates or deactivates the screen, when the screen is moved relative to the axis provided according to the invention.

According to a further possible configuration of the introduced user interface, provision is made for the apparatus to be a vehicle.

The introduced user interface is provided in particular for controlling at least one function of a vehicle and is advantageously arranged on a dashboard of a respective vehicle in order to be operated by a driver or a passenger of the vehicle. Of course, the introduced user interface is also suitable for controlling any other technical apparatus.

Further advantages and configurations of the invention will become apparent from the description and the accompanying drawings.

It is to be understood that the afore-mentioned features and those yet to be explained are applicable not only in the respectively specified combination, but also in other combinations or alone, without departing from the scope of the present invention.

Embodiments of the invention are schematically illustrated in the drawings and will be described schematically and in detail with reference to the drawings.

FIG. 1 shows a possible configuration of the user interface according to the invention.

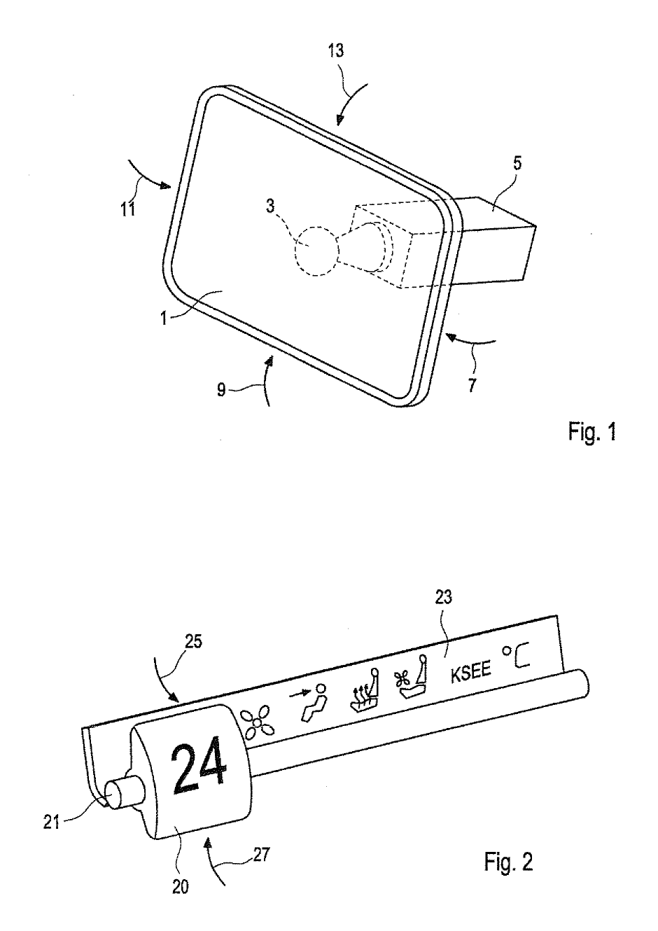

FIG. 2 shows a further possible configuration of the user interface according to the invention.

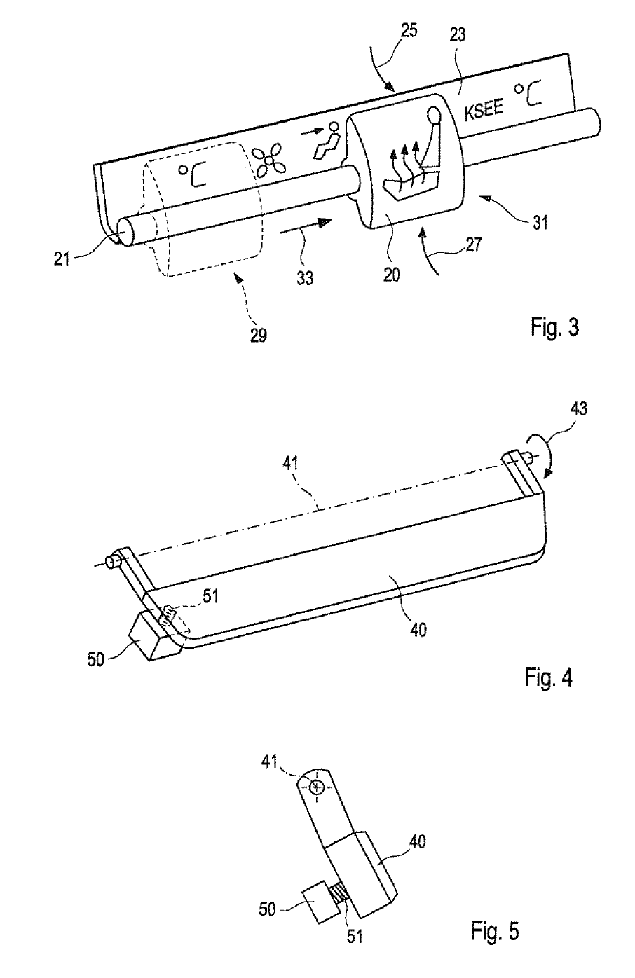

FIG. 3 shows a modified configuration of the user interface of FIG. 2.

FIG. 4 shows a further possible configuration of the user interface according to the invention.

FIG. 5 shows a cross-section of the user interface of FIG. 4 with a switch associated with the user interface.

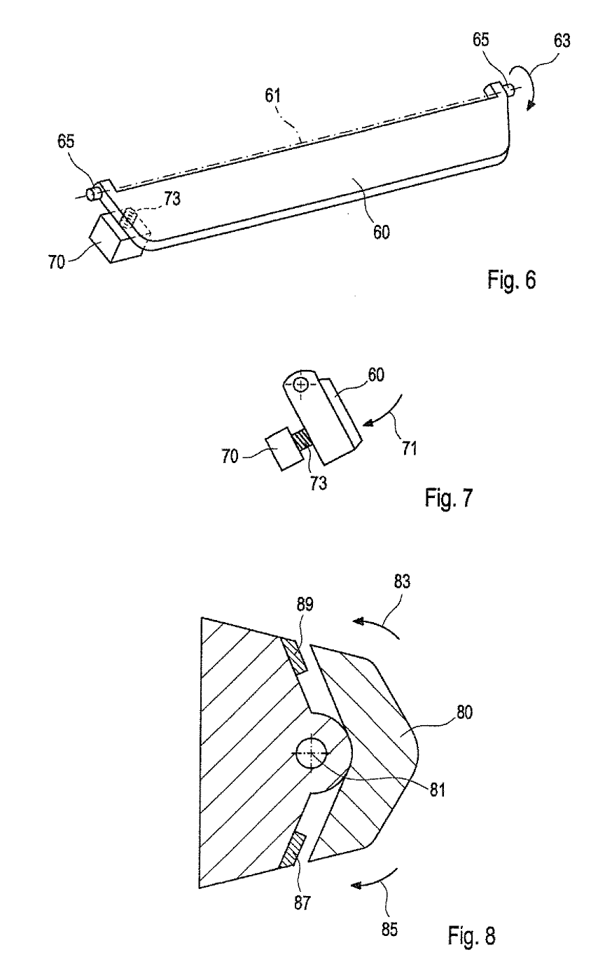

FIG. 6 shows a further possible configuration of the user interface according to the invention.

FIG. 7 shows a cross section of the user interface of FIG. 6 with a switch associated with the user interface.

FIG. 8 shows a possible configuration of the screen provided according to the invention.

FIG. 1 shows a screen 1 which is arranged on an axis 5 by means of a retaining element 3. The retaining element 3 is designed as a ball joint, so that the screen 1 can be moved relative to the axis 5, as indicated by arrows 7, 9, 11 and 13. By a change in position of the screen 1, e.g. according to arrow 7, a switch arranged in a corresponding movement path of the screen 1 can be activated in order to activate or deactivate a corresponding function.

FIG. 2 shows a screen 20 which is laterally displaceable along an axis 21 relative to the axis 21 in order to change a functionality visualized on the screen 20 in dependence of functions depicted on a display 23. This means that the screen 20 is laterally shifted on the axis 21 and a functionality visualized on the screen 20, or corresponding control elements illustrated on the screen, is/are suited in dependence on a current position of the screen 20 on the axis 21 to a function that corresponds to the current position of the screen 20 and depicted on the display 23. In the case illustrated here, the functionality displayed by the screen involves a sub-function for controlling a temperature. This means that activation of the function depicted on the display 23 results in activation of a corresponding sub-function and control symbols are visualized on the screen 20 in order to set the temperature. Accordingly, to adjust the temperature, the control symbols which are displayed on the screen and activated by tilting the screen, i.e. are switched to a controllable state, are activated by a tapping or touching and an air-conditioning apparatus is operated accordingly.

In FIG. 3, the screen 20 of FIG. 2 has been laterally moved along the axis 21 from a position 29 to a position 31, as indicated by arrow 33. Here, the screen 20 is used directly for controlling a seat heating control function. For this purpose, the screen 20 is to be rotated or tilted about the axis 21, as indicated by arrows 25 and 27, to turn on or off respective elements of the seat heating. This means that a movement of the screen 20 in the direction of the arrow 25 causes activation of a control element, such as, e.g., a seat heating control unit, and, moreover, direct control of also the elements of the seat heating.

FIG. 4 illustrates a screen 40, which is arranged for movement along an axis 41 in relation to the axis 41, as indicated by arrow 43. So as to feed back a selection of a control element displayed on the screen 40 by a user to the user, the screen 40 is in operative contact with a switch 50, which is shown in detail in FIG. 5.

FIG. 5 shows in detail the switch 50 of FIG. 4, which includes a mechanical spring 51 which is compressed in the direction of the switch 50, when the screen 40 moves about the axis 41. Due to the compression of the mechanical spring 51 of the switch 50, the mechanical spring 51 provides a force which opposes a force provided for moving the screen 40 and limits, for example, a movement path of the screen 40. As a consequence of the force applied by the mechanical spring 51, a user of the screen 40 is provided with a haptic feedback. The switch 50 can hereby include e.g. a pressure point or a button, which causes activation of a respective control when the latter is contacted by the screen 40.

FIG. 6 illustrates a screen 60, which is arranged for movement along an axis 61 in relation to the axis 61, as indicated by arrow 63. In order to feed back a selection of a control element displayed on the screen 60 by a user to the user, the screen 60 is in operative contact with a switch 70, which is shown in detail in FIG. 7. Here, the axis 61 is guided through retaining elements 65, which are arranged at a short distance to the screen 60.

FIG. 7 illustrates in detail the switch 70 of FIG. 6, which includes a mechanical spring 73 which is compressed, when the screen 60 moves about the axis 61 in the direction of the switch 70, as indicated by arrow 71. Due to the compression of the mechanical spring 73 of the switch 70, the mechanical spring applies a force which opposes a force exerted for movement of screen 60 and, for example, limits a path of movement of the screen 60. As a result of the force applied by the mechanical spring 73, a user of the screen 60 is provided with a haptic feedback when activating the switch 70.

FIG. 8 shows a screen 80 in the form of a tilting display, which is movably arranged on an axis 81, i.e. it is to be tilted about the axis 81 or can be tilted about the axis 81, as indicated by arrow 83 and 85. Upon a tilting movement of the screen 80, the screen 80 is pushed depending on the tilting movement in the direction of the arrow 83 or the arrow 85 toward a switch 87 or 89, and a respective switch 87 or 89 is activated so as to generate a control command to activate a function.

It is also conceivable to provide a bar, along which several tilting displays are arranged, with each tilting display in turn being assigned to a specific function, which can be both activated and then controlled by a defined movement of the tilting display. For example, such a bar can be provided for climate control in a motor vehicle, wherein e.g. a tilting display for controlling the temperature, a tilting display for controlling air circulation and a tilting display for controlling a seat heating are configured.

What is claimed is:

1.-14. (canceled)

15. A method for controlling a function of an apparatus, comprising:
mounting a screen via a retaining element on an axis for rotation about the axis;
shifting the screen along the axis and in relation to a display unit;
selecting the function in dependence on an orientation of the screen relative to the display unit;
arranging a switch on a movement path of the screen; and
activating a switch in response to a tilting movement of the screen on the movement path in relation to the axis to activate or deactivate a control element for controlling the function.

16. The method of claim 15, wherein the screen is arranged on the axis such that the axis forms a horizontal axis or a vertical axis or an applicator axis in relation to the screen.

17. The method of claim 15, wherein the retaining element embraces the axis.

18. The method of claim 15, further comprising providing a haptic feedback of an activation state of the function for a user by a spring element of the switch.

19. The method of claim 18, further comprising:
establishing a communicative connection of the switch with the screen;
transmitting the activation state of the function via the communicative connection to the screen; and
displaying the activation state of the function on the screen.

20. The method of claim 15, further comprising:
establishing an operative contact of the switch with the screen; and
guiding the screen by the switch as the screen is tilted relative to the axis along the movement path.

21. The method of claim 15, wherein the screen is tilted about the axis to activate or deactivate the function.

22. The method of claim 15, wherein the function to be controlled is selected from a multiplicity of functions to be controlled by moving the screen laterally along the axis.

23. The method of claim 15, wherein the screen is a touch-sensitive screen, and further comprising associating a control symbol with the control element and displaying the control symbol on the screen to allow control of the function.

24. A user interface, comprising:
an axis;
a screen arranged on an apparatus and movable along the axis;
a retaining element mounting the screen for movement about the axis on a movement path; and
a switch arranged on the movement path of the screen and activated when the screen is tilted relative to the axis,
said screen comprising a control unit configured to detect activation of the switch and in response to the activation of the switch to activate or deactivate a control element for controlling a function of the apparatus.

25. The user interface of claim 24, wherein the switch comprises a spring element, said switch being configured to guide the screen upon the movement path when the screen is moved relative to the axis.

26. The user interface of claim 24, wherein the apparatus is a vehicle.
